(19) United States
(12) Patent Application Publication
(10) Pub. No.: US 2009/0265767 A1
(43) Pub. Date: Oct. 22, 2009

(54) METHODS AND ARRANGEMENTS FOR PREFIX MANAGEMENT IN MOVING NETWORKS

(76) Inventors: Johan Rune, Lidingo (SE); Mattias Pettersson, Lund (SE)

Correspondence Address: ERICSSON INC., 6300 LEGACY DRIVE, M/S EVR 1-C-11, PLANO, TX, 75024, US

(21) Appl. No.: 12/439,409

(22) PCT Filed: Aug. 30, 2006
(86) PCT No.: PCT/SE2006/050306

§ 371 Date: Mar. 13, 2009

(51) Int. Cl. H04L 9/32; G06F 7/04

(52) U.S. Cl. 726/5; 726/3

(57) ABSTRACT

The present invention relates to prefix management in a moving network comprising a first mobile router which is assigned a first prefix for use when passing traffic to and from a home agent with which the first mobile router is associated, and a second mobile router. The present invention relates to methods and arrangements in the first mobile router, the second mobile router and the home agent for delegating the right to use said first prefix to said second mobile router in a secure manner by means of first and second authentication information that may be compared to verify that the second mobile router has the right to use the first prefix.

### FIELD OF THE INVENTION

The present invention relates to methods and arrangements in mobile communication systems, and more particularly, to methods and arrangements for management of prefixes used in moving networks.

### BACKGROUND

A moving network is defined as a network that is movable in relation to its home network. A moving network can change its point of attachment to a fixed infrastructure or it may have many points of attachment to a fixed infrastructure, but it is still able to communicate with a home network through a mobile router having access to an external access through which all communication nodes in the moving network can communicate. Such a communication node in a moving network is called a moving network node. In the case of a moving network on e.g. an airplane, the moving network will comprise communication nodes, which may be different users' communication devices, such as laptops, mobile phones, PDAs (Personal Digital Assistants) etc., which communication nodes use wireless or wireline communication to communicate with a mobile router within the airplane, such that all communication destined to an external address will pass via the mobile router. A moving network may also be e.g. a Personal Area Network (PAN), wherein a PAN comprises all communication devices belonging to a user and situated within short range radio communication distance from each other. In this application, each node in the moving network or connected to the moving network that works like a router for data originating from a moving network node and destined to an address external of the moving network is defined as a mobile router. Examples of such mobile routers are: a PAN device working as a router in a PAN, and a router in a moving network on a vehicle. Note that a node may have both roles, i.e. being both a moving network node and a mobile router, for example a PAN device such as a mobile phone in a PAN.

“The Network Mobility (NEMO) Basic Support Protocol”, by Devarapalli et al, published in January 2005 as a Request For Comments (RFC) 3963 by the Internet Engineering Task Force, identifies a protocol that enables a moving network to attach to different points in the Internet. The protocol is an extension of Mobile IPv6, and allows session continuity for every communication node (or communication device) in the moving network as the moving network moves. It allows a mobile router to maintain a stable network address prefix for a moving network, even as the mobile router changes its, and thus the moving network's, point of attachment to a fixed network infrastructure. This prefix stability is achieved through a solution similar to the Mobile IPv6 solution, i.e. by making a home agent (HA) in the home network of the mobile router a fixed point of presence for the Mobile Router (MR) and maintaining connectivity between the HA and the MR through a tunnel. The address prefix, which is called Mobile network prefix (MNP) in the NEMO protocol, is allocated from the address range of the home network, and can thus remain the same even as the MR and its network move. When the MR attaches to a network in a new location, it acquires a new care-of address in the new network, which care-of address is used to locate the MR in the new network, but its home address and address prefix are unchanged. However, just like in Mobile IPv6 the MR has to register its new care-of address in the HA in order to maintain the tunnel between the Mobile Router and the Home Agent.

The nodes belonging to the network cluster that moves along with the mobile router are called Mobile Network Nodes (MNNs). In the NEMO basic support protocol they will not change their configuration as the MR changes its point of attachment. In other words, the mobility is transparent to them.

Presently the NEMO basic support protocol allows only a single care-of address to be registered in the HA for a certain MR at any one time. Multiple simultaneous care-of addresses are not allowed and thus multiple simultaneous accesses and MR-HA tunnels are not possible for a MR. Under these conditions, it may support one or multiple MNPs in the moving network. Although the protocol does not exclude multiple MRs in a moving network, it has no explicit support for it and it does not address the issues and problems that arise when multiple MRs, using different MNPs or prefixes, are present in a moving network.

One problem with multiple MRs in a moving network is that all MRs may advertise themselves as default routers. Then an MNN will arbitrarily select one of the MRs for sending default route traffic to. This may conflict with flow management policies that may be defined for the MRs, as a certain policy may indicate that a particular flow should be routed over a specific access that belongs to another MR than the one the MNN selected. Furthermore when the MNN hears the advertisement of two default routers announcing two different prefixes it will configure two addresses and set its default route arbitrarily to either of the MRs, so that all traffic is routed via this MR, even traffic that is associated with the prefix of the other MR. As a result problems with ingress filtering may arise as will be discussed further below.

The multiple MRs of the moving network may offer external network access using different access technologies e.g. GPRS, WCDMA and satellite. Different access technologies may be accessible over different MRs simultaneously so that it is possible to select the access to be used from among a number of possible accesses. Access selection policies may be implemented in the moving network or the end-user may be allowed to influence the choice of access. In order to be able to choose freely between the different available external accesses a packet should be allowed to exit the moving network via the particular MR that is connected to the preferred access. However if ingress filtering is used in the network this may restrict the access selection or cause a conflict between access selection and source address selection in the network.

Ingress filtering is used to stop incorrect (or malicious) packets. It is performed by (arbitrary) routers by inspecting that the source address used in packets leaving a network (upstream, towards the Internet) is topologically correct. The router knows what address space is used below itself and only packets with a source address from that address space should be let through. Therefore a packet with a certain source address may have to exit the moving network via the MR that supports the prefix of the source address in order to avoid ingress filtering, instead of via the MR that is connected to the preferred access. A conflict arises between source address selection and access selection when ingress filtering requires that a packet exit a moving network via a MR that supports the prefix of the source address of the packet and the access selection policies used in the moving network indicate that another access should be used for the packet than the ones that are available from the MR that supports the prefix of the source address. Thus, there is a dependency between source address selection and access selection, which may result in conflicts.

Another problem which may arise in moving networks with multiple MRs using different prefixes is that it may be difficult to maintain prefix consistency if the moving network is involved in splits or merges, especially if the MRs use different HAs. The nature of a moving network is often inherently dynamic. This does not only mean that available external accesses come and go as the moving network moves, disconnects and reconnects, but also that the moving network may split into separate moving networks or merge with another moving network and that the MRs that are present in the moving network may change at any time.

The mechanisms described in the Internet-Draft “Token based Duplicate Network Detection for split mobile network (Token based DND)” by M. Kumazawa et al., published in July 2005, allow multiple MRs (not originally using the same prefix) to support each other's prefix if they share the same HA. The solution is based on a token that is associated with a prefix. It distinguishes between the “owner” and a “borrower” of a prefix. The MR that owns the prefix generates the token and sends it to the HA in the BU and then includes it in its Router Advertisements. If another MR subsequently sends a BU with the same prefix in the Mobile Network Prefix option it has to include the token associated with the prefix (assumedly received in a Router Advertisement from the owner of the prefix). The HA compares the prefix and token with the ones it has previously stored and if they match, the MR is accepted as a borrower of the prefix. If the MR fails to supply this token or supplies another token, the HA will not accept the MR as a borrower of the prefix.

A shortcoming of the solution described in the above mentioned Internet-Draft is that it is limited to scenarios when the involved MRs share the same HA. Another significant problem is that the MR that owns the prefix has no control over which MRs that borrows the prefix. Any MR (using to the same HA) that receives the broadcast token will be able to use the prefix associated with the token after contacting the HA. The solution is insecure, because it lacks protection against malicious nodes (MRs or MNNs) pretending to be the owner of a prefix. Hence a malicious node may e.g. falsely update the token, or replay a correct token in a moving network where the rightful owner of the prefix is not present, thus interfering with the correct prefix usage and potentially creating prefix inconsistencies with the same prefix in use in different moving networks.

The Internet-Draft “Neighbor MR Authentication and Registration Mechanism in Multihomed Mobile Networks” by Seongho Cho et al., published in April 2004, describes a solution that allows a MR to forward packets to and from the HA of a neighbor MR, wherein the source address of a forwarded packet has a prefix supported by the neighbor MR. The purpose is to enable that neighboring MRs can be used to provide alternative paths for fault recovery and/or load sharing. The Router Advertisements are extended with the home address (HoA) and care-of address (CoA) of the sending MR. A MR gathers information about its neighboring MRs by listening to Router Advertisements and collecting the HoA, CoA and MNP of each identified neighbor MR. The retrieved HoA and CoA are “authenticated” through the return routability test of MIPv6, but the validity of the MNP is not verified. During the return routability test the MR also retrieves the HA address of a neighboring MR. A MR reports the retrieved neighbor information to its HA through extensions to the BU. The HA can then use this information to establish an alternative bi-directional tunnel to a neighbor MR to provide redundancy for fault recovery and/or load sharing.

The most serious deficiency of the solution described in the Internet-Draft “Neighbor MR Authentication and Registration Mechanism in Multihomed Mobile Networks” is that it does not enable a security relation between the HA and the neighbor MR. Thus, the HA will not be able to authenticate this MR and the signaling between the HA and this MR will be unprotected as well as the traffic in the bidirectional tunnel. Moreover, the “authentication” of the neighbor information is deficient. It verifies the binding between the CoA and the HoA, but it does not verify that they belong to the MR that announces these addresses in its Router Advertisements. This means that an attacker could first find out CoA and HoA of another MR (which may be located anywhere) and then announce these parameters in a false Router Advertisement. Listening MRs would not be able to detect that the information is false, since the return routability test would succeed. Thus, the neighbor MRs as well as their respective HAs would be fooled by the attacker.

The mechanisms described in the document “IPv6 Multihoming Support at Site Exit Routers” by Hagino, J et al., published in October 2001 as Request For Comments 3178 by the by the Internet Engineering Task Force, provide redundancy and prefix support to fixed exit routers that are primarily/originally connected to different ISPs. The solution addresses the problem of achieving redundant connectivity from a multi-homed fixed site having multiple ISPs by establishing fall-back links between site edge routers and the ISPs.

The solution described in the aforementioned document is a purely configuration-based solution for fixed networks and it is not directly applicable to moving networks.

### SUMMARY OF THE INVENTION

Some problems and difficulties which may arise when a moving network includes several mobile routers using different prefixes have been discussed above. An object of the present invention is to provide methods and arrangements that allow for improved prefix management in a moving network with multiple mobile routers using different prefixes.

The above stated object is achieved by means of a first mobile router, a second mobile router, a home agent, a communications system, a method in a first mobile router, a method in a second mobile router and a method in a home agent, having the features defined in the independent claims. Preferred embodiments are defined in the dependent claims.

The basic idea of the present invention is to provide methods and arrangements that support delegation of the right to use a prefix from one mobile router, which has been assigned the prefix, to another mobile router in a moving network. Implementation of the basic idea of the present invention requires new methods and arrangements, which are all provided according to different aspects of the present invention.

According to a first aspect the present invention provides a method for prefix management in a first mobile router of a moving network. The first mobile router is assigned a first prefix for use when passing traffic to and from a home agent with which the first mobile router is associated. The method comprises establishing a communications connection with a second mobile router of the moving network. The method further comprises delegating the right to use the first prefix to the second mobile router by transferring first prefix delegation information to the home agent and transferring second prefix delegation information to the second mobile router over said communications connection, which first and second prefix delegation information includes first and second authentication information respectively that may be compared to verify that the second mobile router has the right to use the first prefix.

According to a second aspect the present invention provides a method for prefix management in a second mobile router of a moving network. The method comprises establishing a communications connection with a first mobile router of the moving network. The first mobile router is assigned a first prefix for use when passing traffic to and from a home agent with which the first mobile router is associated. The method further comprises receiving second prefix delegation information from the first mobile router over the communications connection delegating the right to use the first prefix to the second mobile router, which second prefix delegation information includes second authentication information that may be compared to first authentication information to verify that the second mobile router has the right to use said first prefix. The method also includes sending a request for prefix delegation utilization to the home agent which utilization request includes the second authentication information and establishing a bidirectional tunnel for passing traffic between the second mobile router and the home agent using the first prefix.

According to a third aspect, the present invention provides a method in a home agent having an associated first mobile router of a moving network. The first mobile router is assigned a first prefix for use when passing traffic to and from the home agent. The method comprises the step of receiving first prefix delegation information from the first mobile router delegating the right to use the first prefix to a second mobile router of the moving network. The first prefix delegation information includes first authentication information. The method further comprises the step of receiving a request for a prefix delegation utilization from the second mobile router. The utilization request includes second authentication information. Yet a further step of the method includes authorizing the prefix delegation of the first prefix to the second mobile router if a comparison of the first authentication information and the second authentication information verifies that the second mobile router has the right to use the first prefix. The method also includes the step of establishing a bidirectional tunnel for passing traffic between the second mobile router and the home agent using the first prefix if the prefix delegation was authorized.

According to a fourth, fifth, sixth and seventh aspects the present invention also provides a first mobile router, a second mobile router, a home agent and a communications system that can be used to perform the methods according to the first, second and third aspect of the present invention.

An advantage of the present invention is that it can be used to ensure that all MRs in a moving network consistently support the same prefixes—even when the MRs use different HAs.

Another advantage of the present invention is that it allows a moving network to benefit from the advantages of multi-homing, e.g. path redundancy, even when the multi-homing is achieved through multiple MRs using different MNPs.

Yet another advantage of the present invention is that it enables decoupling of source address selection from external access selection, thus facilitating efficient and consistent flow management mechanisms in a moving network with multiple MRs and multiple MNPs. Using the present invention, MNNs can freely select source address while ingress filtering rules are honored and flow management policies (i.e. rules for external access selection per flow) are still followed.

A further advantage of the invention is that it can be used to maintain prefix consistency and functioning routing in moving networks that go through splits and/or mergers.

Yet a further advantage of the present invention is that is has no impact on the MNNs in terms of new requirements on functions or behavior. The solution is implemented solely in the involved MRs and HAs. This is an important property of the invention to avoid backwards compatibility problems and other deployment problems, since potential MNNs are numerous and hard to control in terms of implemented software, whereas MRs and HAs are few and assumedly under administrative control.

Further advantages and features of embodiments of the present invention will become apparent when reading the following detailed description in conjunction with the drawings.

### BRIEF DESCRIPTION OF THE DRAWINGS

FIG. 1 is a schematic block diagram of a Vehicle Area Network (VAN) in which the present invention may be used.

FIG. 2 is a schematic diagram illustrating a first phase of an embodiment of a prefix delegation procedure.

FIG. 3 is a schematic diagram illustrating a second phase of the embodiment of the prefix delegation procedure.

FIG. 4 is a schematic diagram illustrating a third phase of the embodiment of the prefix delegation procedure.

FIG. 5 is a schematic diagram illustrating a fourth phase of the embodiment of the prefix delegation procedure.

FIG. 6 is a schematic diagram illustrating a fifth phase of the embodiment of the prefix delegation procedure.

FIG. 7 is a schematic diagram illustrating an alternative fifth phase of the embodiment of the prefix delegation procedure.

FIG. 8 is a schematic block diagram of another Vehicle Area Network (VAN) in which the present invention may be used.

FIG. 9 is a schematic block diagram of a Personal Area Network (PAN) in which the present invention may be used.

FIG. 10 is a schematic block diagram of another Personal Area Network (PAN) in which the present invention may be used.

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like numbers refer to like elements.

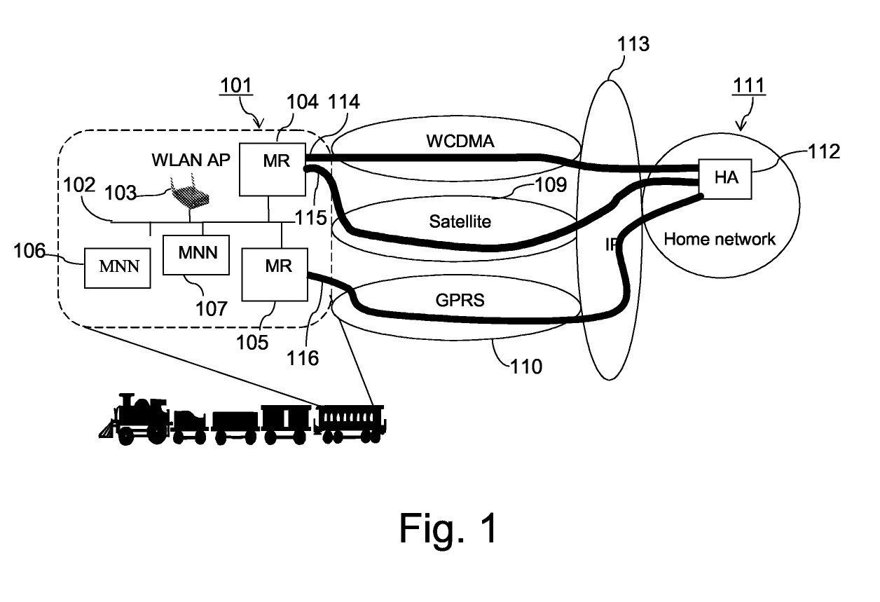

The present invention is applicable in moving networks having multiple mobile routers (MRs) using different prefixes. An example of a moving network in which the present invention may be implemented is illustrated in FIG. 1 which shows a Vehicle Area Network (VAN) 101 within a public transportation vehicle (e.g. a bus, a train, an airplane). The internal network 102 within the vehicle can be some sort of switched Ethernet with both Ethernet ports and WLAN access points 103 deployed. The internal network also has multiple MRs 104, 105 which act as gateways for external communication for all mobile network nodes (MNNs) 106, 107 inside the vehicle. The MRs are also responsible for mobility management for the entire network, i.e. mobility management is totally transparent to the MNNs entering the vehicle. The external network accesses 108, 109, 110 from the vehicle are based on one or several different access technologies, e.g. General Packet Radio Service (GPRS), Wideband Code Division Multiple Access (WCDMA), and satellite. Several of these accesses can be available at the same time depending on for instance coverage and operator policies. FIG. 1 also shows the home network 111 and the home agent (HA) 112 that the MRs are communicating with via an external IP network 113. The MRs 104, 105 need to establish one tunnel to the HA 112 for each available external access. The example in FIG. 1 shows three tunnels 114, 115, 116 from the MRs (two from the MR 104, one from the MR 105) to the HA 112. The MRs may share the same HA and the same prefix from the address range of the home network, but it is also possible that the MRs have different prefixes and possibly also different HAs. The present invention may be useful in scenarios where the MRs have different prefixes.

The basic concept of the present invention is that a MR is allowed to delegate its right or authority to use a certain prefix to another MR. The MR that delegates its right to use one or more of the prefixes will hereinafter be referred to as a delegating MR and the MR that receives the delegated right to use one or more prefixes will hereinafter be referred to as a receiving MR. To enable the receiving MR to use the delegated right the delegating MR also delegates a MR-HA relation to the receiving MR, or, in other words, bootstraps the receiving MR and the HA with the data and credentials required for a security relation as will be explained in further detail below. The prefix delegation of the present invention provides the receiving MR with the ability to support the prefix of the delegating MR and use the delegating MR's HA for traffic to and from the moving network.

For the understanding of the following detailed description of the present invention and different embodiments the interpretation of a number of terms are important:

The term “prefix right delegation” or shorter “prefix delegation” will in this application be used to refer to the act performed by a delegating MR to delegate to another receiving MR the right to use one or more address prefixes. After a prefix right delegation has been completed, both the delegating MR and the receiving MR can support the delegated prefix or prefixes.

The MR that has been assigned a certain prefix by its own right (i.e. not using a delegated right) will herein be referred to as a “primary prefix holder”. Examples of this kind of prefix assignment are prefix assignment between the MR and its HA or home network, and static configuration of a prefix in the MR.

A MR that has been assigned a certain prefix based on a delegated right will herein be referred to as a “secondary prefix holder”.

The term Home Agent (HA) used in the application should be interpreted as any node in a home network working like a mobile anchor point to the moving network, i.e. facilitating communication from the moving network over an external network and the home network.

A MR is herein said to “belong” to a HA if it has a regular (i.e. not resulting from a delegation) security relation with the HA. A HA's MRs are the set of MRs that belong to the HA.

The term Internet Key Exchange (IKE) is herein used to refer to either version 1 (IKEv1), version 2 (IKEv2) or future versions or equivalents of the protocol.

In the world of communication technologies the term credentials is sometimes used to refer to an identity and data associated with the identity, which data is used to prove the authenticity of the identity (or proof of identity ownership with other words). Other times the term credentials refer only to said data associated with the identity, but excluding the identity itself. In this document the latter meaning of the term is used, i.e. the term credentials refers to data that is associated with an identity and which is used for proving ownership or authenticity of this identity. Examples of credentials include pre-shared key, cryptographic key certificate, password, PIN code, etc. In addition, the term “set of credentials” is herein used as the equivalence of credentials and may consist of a single or several pieces of data.

In order to implement the present invention the delegating MR, the receiving MR and the HA need to be adapted to be able to handle prefix delegations in accordance with the present invention. The delegating MR will have to transfer certain prefix delegation information to the receiving MR and to the HA. The delegation information that the receiving MR and the HA receive from the delegating MR differs in different embodiments of the invention. The prefix delegation information that is sent to the receiving MR may be the same information that is sent to the HA or it may differ. However both the prefix information that is sent to the receiving MR and the prefix information that is sent to the HA must include authentication information that can be compared to verify that the receiving MR has the right to use the delegated prefix. The authentication information may e.g. be a delegation MR-ID and a set of credentials. The delegation MR-ID is identity information that the delegating MR generates and which is used to identify a particular prefix delegation. In other words, the delegation MR-ID is an identity that the delegating MR generates and which is to be used as an identity by a receiving MR, in place of the receiving MR's regular identity, when communicating with the HA of the delegating MR in conjunction with a certain delegation. The set of credentials may for instance be a pre-shared key, a certificate, a password, a pin code or similar that is associated with the delegation MR-ID. The delegation MR-ID and the set of credentials are used to create a security relation between the receiving MR and the HA. Note that the term “set of credentials” as used herein may consist of a single piece of information such as a pre-shared key or may include several pieces of information that may be used to authenticate the prefix delegation.

According to embodiments of the present invention the HA and the receiving MR are arranged to store data associated with prefix delegations in a HA delegation context and a receiving MR delegation context respectively.

The HA delegation context is a set of data stored in the HA. The data includes the information that is required to manage the delegation and to interact with the delegating MR and the receiving MR in the context of the delegation. The HA delegation context may e.g. include:
The identity of the delegating MR (e.g. Network Access Identifier (NAI) or Home Address (HoA)).
The delegated prefix(es).
The lifetime of the delegation (normally set to expire simultaneously with the delegating MR's binding in the HA).
A delegation MR-ID (to be used as identity by the receiving MR during e.g. an Internet Key Exchange (IKE) procedure towards the HA).
A pre-shared key (or other set of credentials associated with the delegation MR-ID).
Possibly a delegation ID.
A determined trust level. This is needed only if the HA gives differential treatments to delegations with different trust levels.
Possibly the HoA of the receiving MR. (This is preferably the receiving MR's own (regular) HoA, but it is also possible that it is a HoA assigned by the HA itself or by the delegating MR. In the latter two cases it would be an address from the address range of the HA's network). It is not necessary to include the HoA of the receiving MR in the HA delegation context, since it will anyway be included in the HA's data record for the binding between the receiving MR's Care-of Address (CoA) and HoA.

The receiving MR delegation context is a set of data stored in the receiving MR. The data includes information needed by the receiving MR to be able to use the delegation, i.e. to interact in a useful manner with the HA that is responsible for the delegated prefix(es). The receiving MR delegation context may e.g. include:
The delegated prefix(es).
The lifetime of the delegation (normally set to expire simultaneously with the delegating MR's binding in the HA).
The address of the HA that is responsible for the delegated prefix(es).
A delegation MR-ID (to be used as identity by the receiving MR during e.g. an IKE procedure towards the HA).
A pre-shared key (or other set of credentials associated with the delegation MR-ID).
Possibly the identity of the delegating MR (e.g. NAI or Internet Protocol (IP) address).
Possibly a delegation ID.
Possibly the HoA associated with the delegation, in case a HoA was received from the delegating MR.

According to the present invention a delegating MR is allowed to delegate its right/authority to use a certain prefix to another receiving MR. This delegation should normally only be valid while the two MRs are present in the same moving network. To enable the receiving MR to use the delegated right the delegating MR also delegates a MR-HA relation to the receiving MR, or, in other words, bootstraps the receiving MR and the HA with the data and credentials required for a security relation. The receiving MR can then support the prefix of the delegating MR and use the delegating MR's HA for traffic (using the concerned prefix) to and from the moving network. If desired, the roles of the two MRs can then be reversed (resulting in “cross-delegation” of prefix rights), so that both MRs support each other's prefixes. This allows the MRs to support a consistent set of prefixes for the benefit of all the nodes in the moving network.

The prefix right delegation according to an embodiment of the present invention comprises five phases:
Phase 1: Request of prefix right delegation.
Phase 2: Identify the receiving MR, determine trust level and establish secure communication between MRs.
Phase 3: Delegation.
Phase 4: Utilization.
Phase 5: Revocation.

The above five phases are elaborated in more detail below.

### Phase 1: Request of Prefix Right Delegation

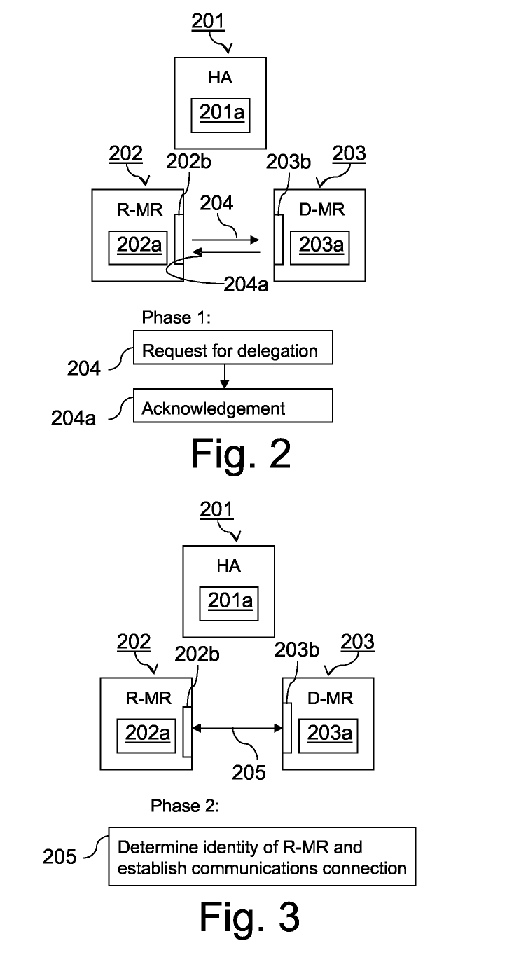

Phase 1 is illustrated by means of a schematic block diagram in FIG. 2. FIG. 2 illustrates a home agent (HA) 201, a receiving mobile router (R-MR) 202 and a delegating mobile router (D-MR) 203. In this first phase the potential receiving MR may request another (potential delegating) MR to delegate the right to use a certain prefix or prefixes in a step 204. This action may have been triggered by detection of the presence of the other (potential delegating) MR, and its prefix(es), in the moving network. The potential delegating MR responds with a positive or negative acknowledgement message in a step 204a.

This is an optional phase that may be omitted. In such case the whole delegation procedure begins when the potential delegating MR initiates phase 2.

### Phase 2: Identify the Receiving MR, Determine Trust Level and Establish Secure Communication Between MRs

If phase 1 is skipped, this is the first phase. Phase 2 is illustrated schematically in FIG. 3. In this phase the potential delegating MR determines the level of trust towards the potential receiving MR and establishes secure communication. The trust level may be determined by exchanging identities and comparing the identity of the other MR with internal (or external) configuration data, step 205. The identities may e.g. be exchanged and authenticated in the context of an Internet Key Exchange (IKE) procedure, which results in established IPsec Security Associations (Ipsec SAs) as defined in RFC 2401 “Security Architecture for the Internet Protocol”, published in November 1998, and its successor RFC 4301 with the same name, published in December 2005 by the Internet Engineering Task Force. The IPsec SAs can be used for secure communication between the MRs. Alternatives to IKE/IPsec include e.g. Transport Layer Security (TLS). In a personal area network (PAN) scenario PAN specific protocols, such as the PAN Management Protocol (PMP) described in the international patent application WO2006/001736 could also be used to determine the trust level and establish secure communication.

If the potential delegating MR cannot authenticate the identity of the potential receiving MR, thus probably implying the lowest trust level, it may still choose to establish secure communication (e.g. through IPsec SAs or using TLS) to the potential receiving MR and to delegate the right to use one or more of its prefixes. This is a matter of policy and configuration, and possibly even user interaction. It should be noted that it is quite possible to establish secure communication between two nodes that are unknown to each other and lack a prearranged security relation using the Diffie-Hellman key exchange procedure.

### Phase 3: Delegation

In this phase the delegating MR transfers the information that is required for a prefix right delegation to the receiving MR and to the HA. The required information will depend on the particular implementation of the invention and may thus differ between different embodiments of the invention. However both the delegation information that is sent to the HA and the delegation information that is sent to the receiving MR will include authentication information such as a delegation MR-ID to be used as identity information identifying the particular delegation and a set of credentials associated with the delegation MR-ID, such as a pre-shared key. In this example the delegating MR transfers to the receiving MR the information needed to establish the receiving MR delegation context discussed above. To the HA it transfers the information needed to establish the HA delegation context. Note that this does not have to include the HoA of the receiving MR. The receiving MR may instead provide the HoA in a Binding Update (BU) that it, according to NEMO basic support protocol, RFC 3963, needs to send to the HA to be able to use the prefix (see phase 4). The HoA is not even an indispensable part of the HA delegation context, since it instead may be included in the HA's data record for the binding between the receiving MR's CoA and HoA.

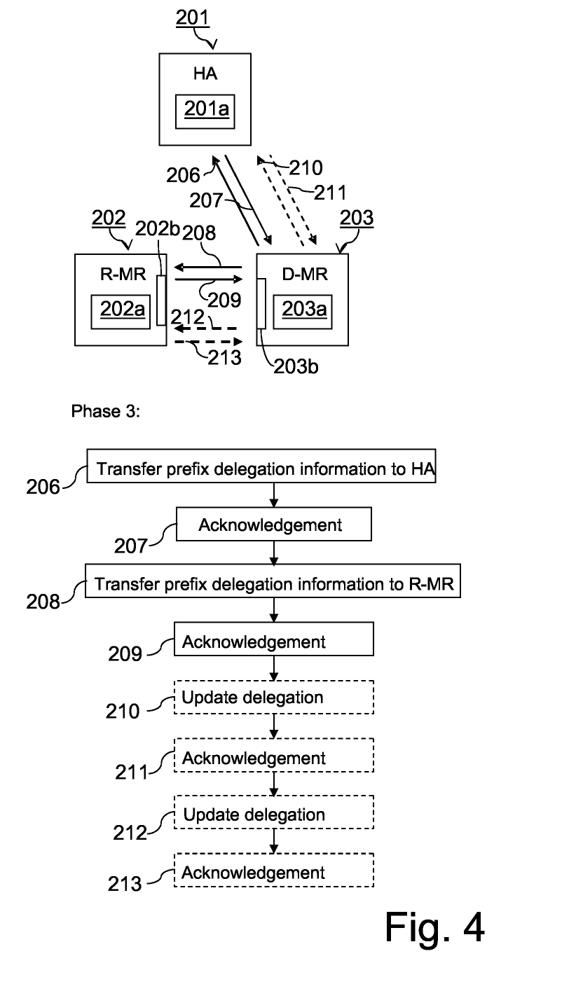

Phase 3 is illustrated schematically in FIG. 4. When transferring information to the HA 201 in a step 206, the delegating MR 203 may use a BU with the delegation related information included in a new (backwards compatible) mobility option. Another possibility would be to use a completely new type of message. The HA 201 may acknowledge the reception of the delegation information by means of sending a Binding Acknowledgement (BA) or a new type of acknowledgement message to the delegating MR in a step 207.

At this point the HA 201 is the instance that ultimately authorizes the delegation and the receiving MR's right to use the concerned prefix. The HA 201 may have been given the right by an administrator to override the delegation. This is a quite natural arrangement, because the prefix being delegated can be seen as owned by the HA or a node in the home network. The prefix has been delegated further to the delegating MR 203 in the first place, e.g. as part of a service subscription model. It is possible that the HA 201 does not accept further delegation of a certain prefix or by a certain delegating MR. It is also possible that the HA does not accept delegation to a certain receiving MR 202. In addition, the HA 201 may not accept too low levels of trust between the delegating MR 203 and the receiving MR 202. A malicious receiving MR may harm the delegating MR (e.g. by traffic interception), but it may also harm the HA to some degree. Therefore it is preferable that the delegating MR informs the HA about the level of trust between the two MRs. The delegating MR may also inform the HA about the method of trust determination and the way the credentials were generated and transferred to the receiving MR. The HA may use such information to refine the trust level determination.

All these criteria for delegation authorization may be based on delegation policies configured in the HA 201 or retrieved from some repository (e.g. an Authentication, Authorization and Accounting (AAA) server).

An alternative conceptual model would be that the prefix actually is owned by the delegating MR 203 in the first place and not by the HA 201. Prefix ownership would then come from the leaves, not from the center (root) of the network. With this model the HA 201 should not be able to override a delegation from a rightful owner of a prefix. The HA would not be the authority point in this context—only a mobility function.

The delegating MR may transfer the delegation information to the receiving MR by means of a new type of message or possibly an existing generic information transfer protocol such as File Transfer Protocol (FTP) in a step 208. An alternative could be to use a PAN specific protocol like the PAN Management Protocol (PMP) mentioned above. The receiving MR may acknowledge reception of the delegation information in a new message type in step 209.

It is often preferred that the delegating MR 203 transfers information to the HA 201 before transferring information to the receiving MR 202. If the HA 201 does not accept the delegation, it indicates this in the responding BA and the delegating MR 203 in turn informs the intended receiving MR 202 of the failure. Transferring delegation information to the HA 201 before the receiving MR 202 also allows the delegating MR 203 to set the lifetime of the delegation to the lifetime received in the BA from the HA 201. In addition, if the HA 201 assigns a HoA for the delegation, this has to be conveyed to the delegating MR in the BA, possibly included in a new (backwards compatible) mobility option, or in a new type of message before the delegating MR 203 can transfer it to the receiving MR 202.

The delegating MR 203 may later extend the lifetime of the delegation using the Binding Update procedure (or new message types), steps 210 and 211. After such a lifetime extension the delegating MR 203 may also update the delegation lifetime in the receiving MR 202 (using new message types, e.g. the same messages types as for the initial delegation), steps 212 and 213. The delegating MR may use the same method for other types of delegation updates, such as adding or removing one or more prefix(es) from/to the delegation.

### Phase 4: Utilization

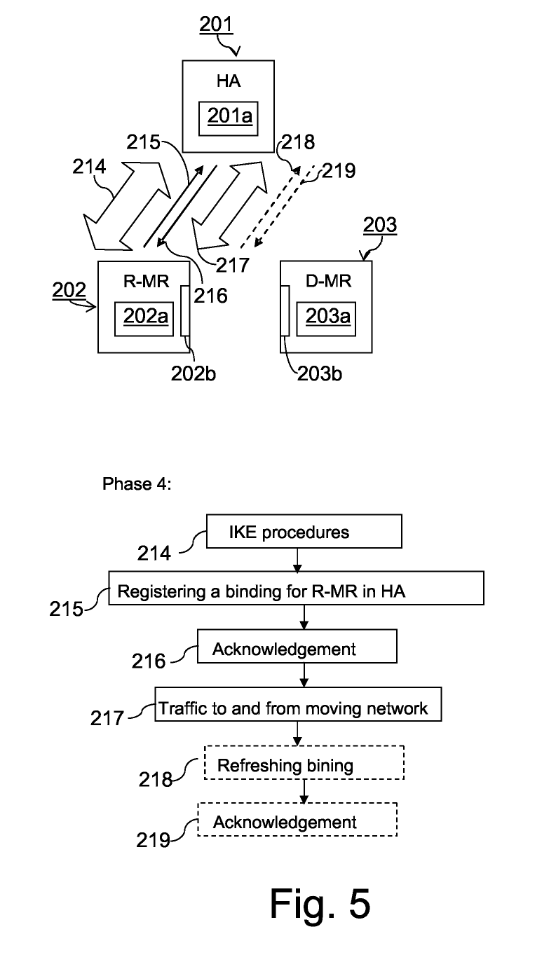

Phase 4 is illustrated in FIG. 5. According to the present example the receiving MR 202 establishes IPsec SAs with the HA 210 through IKE (version 1 or 2) procedures using the received authentication information, in this example a delegation MR-ID and associated pre-shared key (or other set of credentials), in step 214. In this step the HA will receive a delegation MR-ID and proof of possession of its associated set of credentials, e.g. a pre-shared key, from the receiving MR and check that these matches the delegation MR-ID and set of credentials received from the delegating MR. In other words the HA compares the authentication information received from the delegating MR with authentication information received from the receiving MR to verify that the receiving MR has the right to use the delegated prefix. It is also possible to use another authentication and IPsec SA establishment procedure than the IKE procedure, but in order to provide the increased security and protection against malicious nodes it is important that the HA checks that the authentication information, such as a delegation MR-ID and set of credentials, from the delegating MR matches the authentication information from the receiving MR. Matching delegation MR-IDs and sets of credentials will in most cases mean that the delegation MR-IDs and sets of credentials are identical respectively, which is verified by the authentication algorithm. However it is also possible that the sets of credentials are not identical and that a specific algorithm must be used to determine if the delegation MR-IDs and sets of credentials match. The sets of the credentials of the receiving MR and the delegating MR may for instance be the matching keys of a private-public key pair. In another possible embodiment a certificate may be used to verify that the receiving mobile router is allowed to use the delegated prefix. The delegating MR may then issue a certificate that is associated with a delegation MR-ID and a private-public key pair, and the delegation MR-ID, the private-public key pair and the certificate are then transferred to the receiving MR-ID as authentication information. Assuming that the HA is already aware of a public key associated with the delegating MR the delegating MR will in that case only have to transfer the delegation MR-ID as authentication information to the HA. The HA may then use the public key of the delegating MR to verify the certificate and thus also verify that the receiving MR is allowed to use the delegated prefix.

Provided that the authentication procedure was successful, the receiving MR 202 and the HA 201 then act in accordance with the NEMO Basic Support protocol. That is, the receiving MR registers in the HA through a Binding Update procedure and establishes a bidirectional tunnel. In FIG. 5 step 215 illustrates that the receiving MR 202 sends a BU to the HA 201 and step 216 illustrates that the HA sends a BA to the receiving MR. The HA and the receiving MR then use the bidirectional tunnel to pass traffic (illustrated by the arrow denoted 217 in FIG. 5) using the delegated prefix(es) in the source or destination address to and from the moving network.

Optionally the HA may update the lifetime of the delegation in a new (backwards compatible) mobility option in the BA 216. If the BA does not include an explicit delegation lifetime value, the receiving MR may set the delegation lifetime to the maximum of the currently stored remaining delegation lifetime and the lifetime of the binding received in the BA. When the binding is about to time out it is possible that the binding is refreshed by means of another BU, step 218 and another BA, step 219, updating the delegation lifetime.

As with any Binding Update procedure, the HA 201 has the possibility to reject the BU (and indicate this in the BA). When the BU concerns a delegated prefix, a reason for the HA to reject the BU could be that the circumstances around the delegation has changed, e.g. because of updated delegation policies, so that the HA can no longer accept the delegation.

When the receiving MR has established the bidirectional tunnel and is finally capable of (and authorized to) use the delegated prefix(es), it includes the concerned prefix(es) in its Router Advertisements.

### Phase 5: Revocation

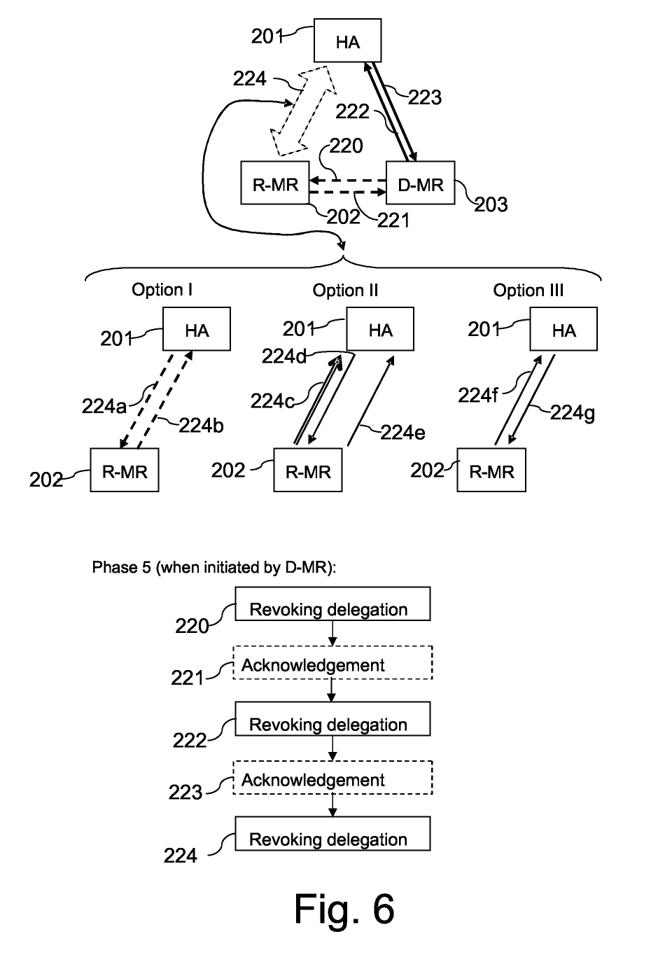

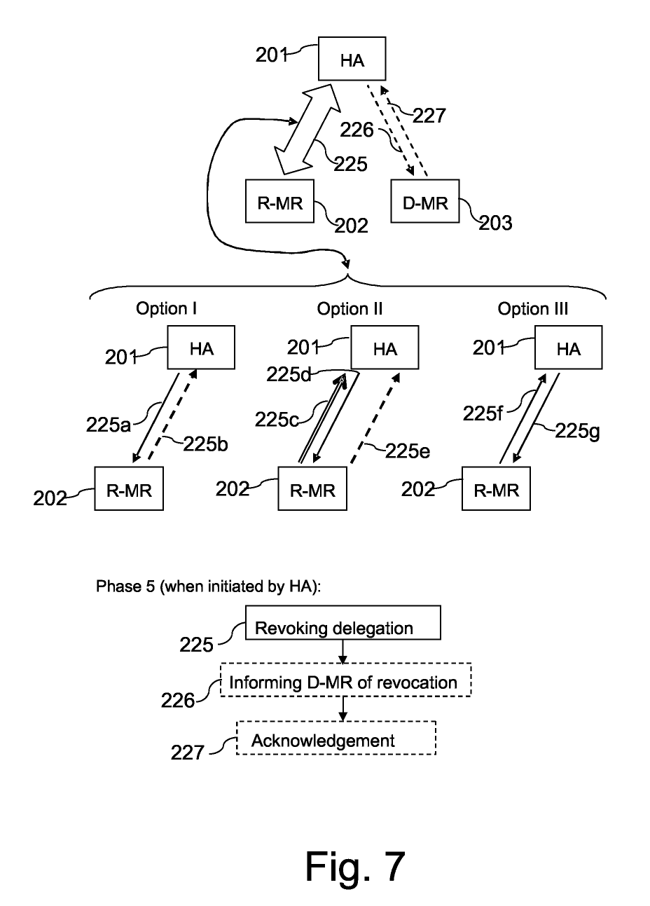

In this example the prefix delegation has a limited, but extendable, lifetime. The delegation can also be explicitly revoked. In phase 5 the delegation is revoked, either explicitly or implicitly. The revocation may be initiated by the delegating MR as illustrated schematically in FIG. 6 (including different options) or by the HA as illustrated schematically in FIG. 7 (including different options). In the former case the delegating MR revokes the delegation by informing the HA (e.g. by setting the delegation lifetime to zero) in a step 222 and maybe, if possible, also informing the receiving MR in a step 220. Otherwise the HA will inform the receiving MR in a step 224, either immediately, using a new type of message or a MIPv6 Binding Error (BE) message, or the next time the receiving MR tries to use the delegation context (i.e. any action belonging to the utilization phase), using a BA or possibly a new type of message. In FIG. 6 step 221 illustrates an acknowledgment of revocation that is sent from the receiving MR to the delegating MR if the revocation message sent in step 220 was received. Step 223 illustrates a BA or possibly a new type of acknowledgment message sent from the HA to the delegating MR to acknowledge receipt of a BU or other message comprising an indication of a revocation of the prefix delegation.

The HA may inform, step 224, the receiving MR of a revocation in many different ways as illustrated in FIG. 6. If the delegating MR did not inform the receiving MR of the revocation or if no acknowledgement was received from the receiving MR in step 221 the HA may revoke the prefix delegation in a new message type or a BE sent in step 224a. The receiving MR may acknowledge reception of this revocation message in step 224b, unless the message sent in step 224a was a BE. Another option is to let the HA inform the receiving MR the next time it receives a data packet sent through the bidirectional tunnel associated with the prefix delegation. Step 224c illustrates that the receiving MR sends a data packet through the bidirectional tunnel. Step 224d illustrates that the HA responds by sending a message, a BE or a new type of message, revoking the delegation to the receiving MR, which in turn acknowledges the revocation message in a step 224e, unless the message sent in step 224d was a BE. Yet another option is that when the receiving MR sends a BU to refresh or update the binding in the HA, step 224f, the HA sends a BA rejecting the BU which indicates revoked delegation as the cause, step 224g.

A possible reason for a delegating MR to revoke a prefix delegation could be e.g. that it discovers that the receiving MR is no longer connected to the same moving network.

The HA may also initiate the revocation. A possible reason for the HA to revoke a delegation could be that the delegating MR's binding is deleted (although it is not certain that this is reason enough in some embodiments). Other reasons may for instance be administrative reasons, e.g. general policy changes or changes in the delegating MR's right to use the concerned prefix or its right to delegate. That the delegating MR's binding times out in the regular way (due to lack of refreshing Binding Updates) should normally not trigger a revocation, since the lifetime of the delegation normally should not have been set to a greater value than the lifetime of the delegating MR's binding in the first place.

Now turning to FIG. 7. When the HA initiates the revocation it informs the receiving MR in a step 225 either immediately, using a new type of message or a MIPv6 Binding Error (BE) message, or the next time the receiving MR tries to use the delegation. The HA may also inform the delegating MR in a new type of message, step 226. The delegating MR may acknowledge reception of the revocation message in a step 227. The HA may inform, step 225, the receiving MR of a revocation in many different ways as illustrated in FIG. 7. The HA may revoke the prefix delegation in a new message type or a BE sent in step 225a. The receiving MR may acknowledge reception of this revocation message in step 225b, unless the message sent in step 225a was a BE. Another option is to let the HA inform the receiving MR the next time it receives a data packet sent through the bidirectional tunnel associated with the prefix delegation. Step 225c illustrates that the receiving MR sends a data packet through the bidirectional tunnel. Step 225d illustrates that the HA responds by sending a message, e.g. a BE or a new type of message, revoking the delegation to the receiving MR, which in turn acknowledges the revocation message in a step 225e, unless the message sent in step 225d was a BE. Yet another option is that when the receiving MR sends a BU to refresh or update the binding in the HA, step 225f, the HA sends a BA rejecting the BU which BA indicates revoked delegation as the cause, step 225g.

As mentioned above the HA may use the MIPv6 Binding Error message to inform a receiving MR of a revoked delegation. The Binding Error message is normally used only by correspondent nodes (i.e. when MIPv6 route optimization is used) and not by HAs. Still, with a new status code indicating “Revoked delegation(s)” the message would serve this new purpose well. If the HA has stored only one delegation associated with the concerned delegation MR-ID (and delegating MR identity), then this new status code is the only required addition to the existing Binding Error message format. This can be generalized to the case when the HA has stored multiple delegations associated with the concerned delegation MR-ID (and delegating MR identity), in which case the Binding Error message would indicate revocation of all these delegations. However, in order to allow the HA to revoke only a subset of multiple delegations associated with the concerned delegation MR-ID (and delegating MR identity), the new status code is not enough. In addition, the Binding Error must include information that identifies the delegations that are revoked. This information is preferably included in a new mobility option or multiple instances of the same new mobility option containing one delegation identification each. The same or similar status code and delegation identification can be used if the HA uses a BA to indicate the revocation.

Phase 5 is optional. If not explicitly revoked, the prefix delegation will sooner or later time out due to lack of refreshing Binding Updates (or other refreshing messages).

There are potentially several alternative ways to identify a specific delegation, the choice of which impacts the properties of the solution in general. If a delegation MR-ID is used as part of the authentication information sent to the HA and the receiving MR one may choose to the delegation MR-ID as a pure node (MR) identifier or as a delegation identifier. Another choice, which has less impact, is whether to use a separate delegation ID.

If the delegation MR-ID is used as a delegation identifier, this means that it is unique per delegation (from a certain delegating MR). Thus, if a delegating MR delegates multiple delegations to the same receiving MR, each of these delegations will involve a unique delegation MR-ID (and preferably, but not necessarily, unique credentials, e.g. a pre-shared key). A delegation would be identified, e.g. during update or revocation, by the delegation MR-ID in combination with the identity of the delegating MR. As a consequence the HA will perceive the receiving MR as multiple MRs—one for each delegation MR-ID. This in turn means that multiple MR-HA tunnels have to be established and multiple Binding Update procedures have to be used. A separate delegation ID would not serve any purpose in this case. All in all, this would be simple, but rather inefficient.

If the delegation MR-ID is used as a pure MR identifier, multiple delegations from a certain delegating MR to the same receiving MR would use the same delegation MR-ID (and the same credentials) in the delegation contexts. If no separate delegation ID is used, a delegation would be identified by the combination of delegation MR-ID, prefix(es) and the identity of the delegating MR. The HA would perceive the receiving MR as a single MR with multiple delegations. That is, a single MR-HA tunnel could be used and a single Binding Update procedure would encompass all the delegated prefixes. A disadvantage is that if a HA wants to reject the “part of” a Binding Update that pertains to one delegated prefix, but accept the “part” that applies to another delegated prefix, more refined result indications would be needed in the Binding Acknowledgement. Such a result indication could e.g. be realized through a status code that means “Binding Update accepted for a subset of the delegations” combined with a new mobility option that would identify either the accepted delegations or the rejected delegations. One reason for such a part acceptance could be that the lifetime of one of the delegations has expired but not for the other(s). Similar refined indications could also be used in a BE, when a HA uses a BE for revocation of one or more delegations.

Another potential consequence of identifying a delegation by the combination of delegation MR-ID, prefix(es) and the identity of the delegating MR would be that care has to be taken to ensure that a delegation update is not confused with a creation of a new delegation. If, for instance, a delegation update contains the old delegation MR-ID and only a new prefix to be added, this could potentially (although the risk would be small) be confused with the creation of a new delegation for the new prefix, unless the message contains an explicit indication (e.g. a flag or separate message types) of whether it signals an update of an existing delegation or a creation of a new one. Another way to avoid the confusion is to always include in the message the delegation MR-ID, the identity of the delegating MR and the current prefixes of a delegation to be updated (as a clear identification of the concerned delegation), followed by the actual updates.

Introduction of a separate delegation ID has some, but small, impact on the solution's properties for the case where the delegation MR-ID is used as a pure MR identifier. In this case a delegation would be identified by the combination of delegation MR-ID, delegation ID and the identity of the delegating MR or, provided that the delegating MR ensures that the delegation ID is unique among all its delegations (i.e. even across multiple receiving MRs), the combination of delegation ID and the identity of the delegating MR. A single MR-HA tunnel and Binding Update procedure would still suffice for all delegations, but the delegation identification in the refined result indication in the BA would be different (as described above) when the delegation ID is introduced.

When a delegation ID is used there is no risk of confusion of creation and update messages and the same message type could, if desired, be used for both actions, without explicit indication of action type.

All the above issues concern situations when a delegating MR issues multiple delegations to the same receiving MR. But why would a delegating MR do that instead of keeping everything in a single delegation—especially since an existing delegation may be updated, e.g. with an additional prefix? A reason for issuing multiple delegations to the same receiving MR may be that the delegating MR wants different delegation properties to be associated with different delegated prefixes. As an example, a delegating MR that wants to delegate the right to use a second prefix to the same receiving MR may want to have a different lifetime for the delegation pertaining to the second prefix. This can be achieved by issuing a new delegation for the second prefix, but not by updating the old delegation with the new prefix.

From the above description of embodiments of the present invention it is apparent that there are several nodes that are involved and interact in the prefix delegation process. These nodes are the delegating MR, the receiving MR and the HA. These nodes must be adapted to support prefix delegation. The person skilled in the art will appreciate that this adaptation in most cases involves loading new software into the different nodes to support the new information exchange between the nodes that is required to implement the prefix delegation. The person skilled in the art will also appreciate that this adaptation of the nodes also can be realized by means of hardware circuits or firmware. The software, firmware or hardware circuits that are included in the HA 201, receiving MR 202 and delegating MR 203 to implement the prefix delegation are illustrated schematically as blocks denoted 201a, 202a and 203a respectively in FIGS. 2-7. Furthermore a communications interface of the delegating MR 203 and a communications interface of the receiving MR 202 for establishing a communications connection between the delegating MR and the receiving MR 202 according to the present invention are illustrated and denoted by 203b and 202b respectively.

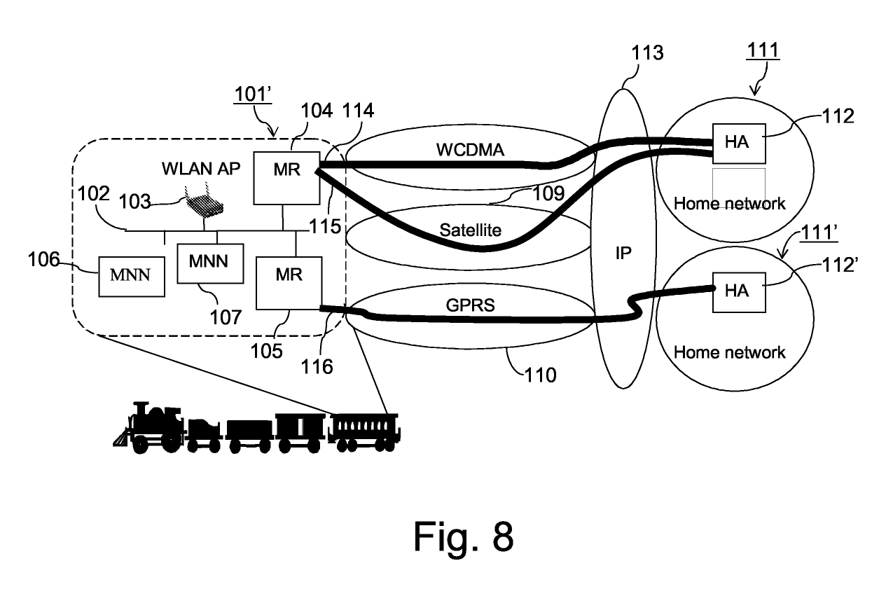

As was discussed above, the present invention may be used in the VAN illustrated in FIG. 1. The present invention may also be used in a VAN 101′ illustrated in FIG. 8. The VAN 101′ in FIG. 8 is similar to the VAN 101 in FIG. 1. The difference is that the mobile routers 104, 105 have different HAs 112 and 112′ located in different home networks 111 and 111′.

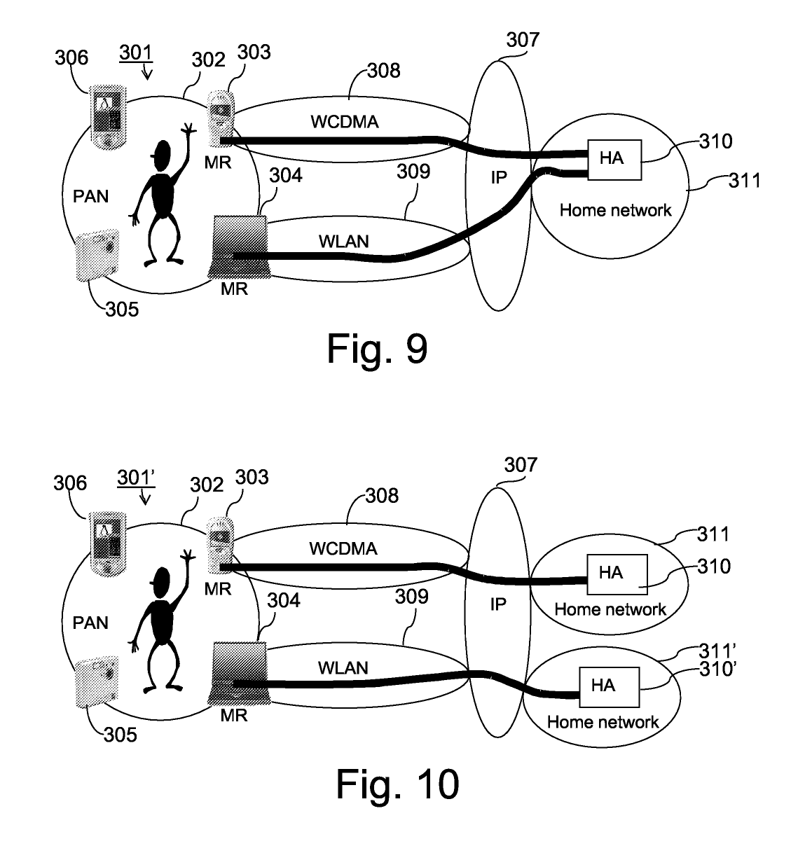

The present invention may also be used in a Personal Area Network (PAN) with one or several MRs that provide the external access to the PAN. A PAN may for instance comprise the gadgets/devices that a user is carrying with him/her or the network within the user's personal car. Examples of two different PANs 301 and 301′ are illustrated in FIGS. 9 and 10. The PANs 301 and 301′ include a switched Ethernet network 302 (illustrated schematically as a circle in FIGS. 9 and 10) based on for instance Bluetooth running a PAN profile. The PANs 301 and 301′ furthermore include a number of nodes in FIGS. 9 and 10 four exemplary nodes are shown: a mobile phone 303, a laptop 304, a digital camera 305 and a PDA 306. In these examples the mobile phone 303 and the laptop 304 act as MRs, which means that they act as routers within the PAN and provide access to an external network 307. In FIGS. 9 and 10 it is illustrated schematically that the mobile phone 303 provides a WCDMA access 308 to the external network 307 and the laptop 304 provides a WLAN access 309. The mobile phone 303 and the laptop 304 are as MRs also responsible for mobility management of the PAN. As in the VAN examples with multiple MRs scenario illustrated in FIG. 1, the MRs in the PAN may share the same HA 310 and the same prefix from the address range of their home network 311, as illustrated in FIG. 9. However, in the PAN scenario it is more likely than in the VAN scenario that different MRs have different HAs 310 and 310′ in different home networks 311 and 311′ and thus different prefixes, which is illustrated in FIG. 10. The two accesses 308 and 309 may well use different operators and thus different subscriptions. As in the previously described VAN scenarios the MRs 303 and 304 need to establish a bidirectional tunnel to the home agent for each available external access.

In a multi-MR, multi-MNP scenario the present invention can be used to allow flow management, involving access selection per flow, to be independent of MR selection and source address selection, while still avoiding ingress filtering problems. This is achieved by ensuring that all MRs in a moving network support all (and thus the same) prefixes. All MRs may by means of the present invention establish tunnels over all their accesses to all HAs. If an MR, for example, has three accesses and there are two involved HAs (for all the MRs in the moving network together), the MR will establish six tunnels. Then the MR can send packets over any of its accesses to any of the HAs that are used in the moving network. Provided that the other MR(s) establish corresponding arrangements, this gives the MR complete freedom to select access independently of source address selection. This approach does not require forwarding of packets between MRs, unless an external access link that is only available from another MR is selected for an outbound packet, according to the flow management policies.

Accordingly the present invention may be used to provide cross-delegations in the moving network 101′ in FIG. 8 such that all MRs 104 and 105 in the moving network support each other's prefixes. When the MR 105 receives an outgoing packet it uses its access selection policies to determine which one of the external accesses that are available in the moving network that the packet should be forwarded over. If the selected access is available only through the other MR 104, the packet is forwarded to this outgoing MR 104. Otherwise, if the selected access is available in the MR 105 itself, then the MR 105 is the outgoing MR. The outgoing MR checks the prefix of the packet's source address and forwards the packet over the selected access through the tunnel to the HA that is associated with the concerned prefix. If the outgoing MR is another MR than the MR 105, it uses its access selection policies to determine which external access to forward the packet over before checking the prefix tunneling the packet to the HA.

As mentioned above an advantageous property of the present invention is that it can be used to harmonize the prefix usage so that all MRs in a moving network consistently support the same set of prefixes. To achieve this each MR in a moving network should delegate the right to use each of its prefixes (for which it is a primary prefix holder) to all other MRs in the moving network that do not support the prefix. This generic rule may however result in redundant delegations. Consider for instance a scenario with three MRs—MR1, MR2 and MR3—in a moving network. Initially MR1 is a primary prefix holder of prefix P1 and MR2 and MR3 are both primary prefix holders of prefix P2. According to the above generic rule MR1 would delegate the right to use prefix P1 to MR2 and MR3 and MR2 and MR3 would both delegate the right to use prefix P2 to MR1. The double delegation to MR1 of the right to use prefix P2 makes one of the delegations redundant.

To avoid redundant delegations it is preferable to use delegation procedures that are initiated with phase 1 in which a receiving MR requests prefix delegation as described above. In the scenario example with three MRs and two prefixes this would mean that MR1 would request either MR2 or MR3 to make it a secondary prefix holder of prefix P2 (i.e. to be delegated the right to use prefix P2), while both MR2 and MR3 would request MR1 to delegate the right to use prefix P1.

Redundant delegations can also be avoided without using phase 1. A simple way would be that the potential receiving MR rejects the delegation, e.g. in step 209 in FIG. 4, if it already is a secondary (or primary) prefix holder of the concerned prefix(es). In combination with this approach it may be preferable to let a MR use a random delay before delegating the right to use a certain prefix after discovering another MR in the moving network that does not support the prefix.

Although avoiding redundant delegations is generally preferable, one may also see advantages in such redundancy. For instance, if, in the above scenario example with three MRs and two prefixes, MR1 has received double delegations of rights to use prefix P2 and one of these delegations times out (or is explicitly revoked/deleted), e.g. because MR2 or MR3 is powered off, then MR1 can still keep supporting prefix P2 without interruption based on the other delegation.

In addition the prefix harmonization that can be achieved in a moving network by means of the present invention makes it possible to benefit from the advantages provided by a multi-homed moving network, e.g. path redundancy, since it provides the possibility to move communication from one MR to another without changing the MNN address for the communication. If it would be necessary to change the MNN address for the communication then most sessions would be broken. This prefix harmonization can be achieved even when the different MRs are using different HAs.

The nature of a moving network is often inherently dynamic. This does not only mean that available external accesses come and go as the moving network moves, disconnects and reconnects, but also that the moving network may split into separate moving networks or merge with another moving network and that the MRs that are present in the moving network may change at any time. As an example, the PAN 301 in FIG. 9 may split into two moving networks or “sub-PANs” where a first sub-PAN comprises the mobile phone/MR 303 and the PDA 306 and the second sub-PAN comprises the laptop/MR 304 and the digital camera 305. The two sub-PANs may then also merge into a single PAN, i.e. changes between these two conditions may occur dynamically. The reason for splitting or merging the PAN 301 may be that even though the user more or less brings a number of devices along in his/her daily life, the devices may not be close enough to each other to communicate at all times. A couple of devices may for instance be left at the user's office desk, while others are brought to a meeting. In another example some of the devices in the user's PAN more or less never leave home. They are part of the merged PAN together with the user's mobile devices when the user is at home, but when the user is away from home his/her home devices form one sub-PAN and his/her mobile devices form another sub-PAN. Still, the home devices may stay connected to a network infrastructure to allow communication in general and specifically to allow the user to communicate with the home devices, e.g. for retrieving information (e.g. from a surveillance camera) or for remote control (e.g. house heating or the kitchen oven).

In the case of a VAN on a train splits and mergers of the VAN may occur when cars are connected and disconnected in various combinations. In order for each car to be able to function independently, each car may have one or more MRs and one or more external network accesses constituting an independent moving network. When two cars are connected, their respective moving networks are merged (through e.g. a simple connector or a layer 2 bridge device). Thus, the network devices in all the cars of a train typically constitute a single moving network with multiple MRs. When a car is disconnected from a train, the moving network is divided into two moving networks, one in the disconnected car and the other one in the remaining car(s). The MRs of the moving network becomes resources that are shared by the MNNs, i.e. the MRs together serve the moving network, providing the MNNs with external network access (e.g. through WCDMA, GPRS and/or a satellite link).

The present invention can be used to maintain prefix consistency in moving networks that go through splits and/or mergers. Dynamic events such as splits and mergers can cause MRs to change prefixes or adopt new ones in order to reestablish prefix consistency after a dynamic event. These prefix changes involve algorithms/principles for prefix selection. When multiple HAs and delegated prefix rights are introduced, the prefix selection algorithms/principles must be slightly adapted to take into account the concepts of primary and secondary prefix holders.

In general it is assumed that a MR advertises all the prefixes that it supports in the moving network, including both the prefixes for which it is a primary prefix holder and the ones for which it is a secondary prefix holder. It is however possible to use the present invention such that a MR only advertises prefixes for which it is a primary prefix holder, but not the ones for which it is a secondary prefix holder. An alternative would however be to associate an indication with each prefix in the Router Advertisement message indicating whether the advertising MR is a primary or secondary prefix holder for the prefix. This indication could be included in the Prefix Information option for each prefix in the Router Advertisement message. Backwards compatibility would be achieved if the “Reserved1” field or “Reserved2” field is used to include the indication. Another way to introduce the new indication in a backwards compatible manner would be to introduce a new option for the Router Advertisement message, containing either both a prefix and its associated indication or only an indication. In the latter case the order in which the options appear in the message would indicate which prefix a certain indication is associated with. This method is backwards compatible, because all nodes should silently ignore any options they do not recognize in a received Router Advertisement message. An advantage with a new indication in the Router Advertisement message would be that a MR that wishes to request to be delegated the right to use a certain prefix easier can identify the MR that is responsible for the prefix (i.e. a MR that is a primary prefix holder for the concerned prefix), which is thus the one to send the request to.

The above embodiments of the present invention were described in conjunction with the NEMO Basic Support protocol, which is defined only for IPv6. However, the principles and mechanisms of the NEMO Basic Support protocol, as well as the mechanisms of the invention, can be generalized to work also in an IPv4 environment. For the NEMO Basic Support protocol this means that the protocol should be specified in terms of extensions to MIPv4 as described in “IP Mobility Support for IPv4” by C. Perkins et al. published in August 2002 as a Request For Comments (RFC) 3344 by the Internet Engineering Task Force instead of extensions to MIPv6 as described in “Mobility Support in IPv6” by D. Johnson et al. published in June 2004 as RFC 3775. Adaptation of the present invention to IPv4 implies that all IPv6 prefixes and addresses are replaced by IPv4 prefixes and addresses. Using ICMPv4 Router Advertisements may also be useful in order to facilitate that MRs discover each other and the prefixes they support. A possible alternative to specifying the NEMO Basic Support protocol in terms of MIPv4 extensions is to use an available mechanism for running MIPv6 over IPv4 (such mechanisms are being worked on in the IETF) to run the NEMO Basic Support protocol in an IPv4 environment. If the interior of the moving network is based on IPv6, no further adaptation is needed. If the interior of the moving network is based on IPv4, the rest of the above described adaptations (i.e. excluding specifying the NEMO Basic Support protocol in terms of MIPv4 extensions) are needed.

In the drawings and specification, there have been disclosed typical preferred embodiments of the invention and, although specific terms are employed, they are used in a generic and descriptive sense only and not for purposes of limitation, the scope of the invention being set forth in the following claims.

1. A method for prefix management in a first mobile router of a moving network, which first mobile router is assigned a first prefix for use when passing traffic to and from a home agent with which the first mobile router is associated, which method comprises the steps of:
establishing a communications connection with a second mobile router of the moving network;
delegating the right to use said first prefix to said second mobile router by:
transferring first prefix delegation information to said home agent; and
transferring second prefix delegation information to said second mobile router over said communications connection, which first and second prefix delegation information includes first and second authentication information respectively that may be compared to verify that the second mobile router has the right to use said first prefix.

2. The method according to claim 1, wherein said step of establishing a communications connection with the second mobile router includes:
determining a trust level of the second mobile router based on identity information received from said second mobile router; and
establishing the communications connection as an IPsec connection or other secure communications connection, and wherein said step of transferring first prefix delegation information to said home agent includes transferring information on said determined trust level to said home agent.

3. The method according to claim 1, further including the step of receiving a request for a delegation of said first prefix from said second mobile router and wherein said step of establishing said communications connection is performed in response to reception of said delegation request.

4. The method according to claim 1, wherein said first prefix delegation information is transferred to said home agent by means of a Binding Update.

5. The method according to claim 1, wherein said second prefix delegation information is transferred to said second mobile router using the File Transfer Protocol, FTP, the Personal Area Network Management Protocol, PMP or the Hyper Text Transfer Protocol, HTTP.

6. The method according to claim 1, including the further step of revoking the delegation of said first prefix to said second mobile router by sending a revocation message to said home agent.

7. The method according to claim 1, including the further step of updating the delegation of said first prefix to said second mobile router by sending a first updating message including changes to said first prefix delegation information to said home agent and sending a second updating message including changes to said second prefix delegation information to said second mobile router.

8. A method for prefix management in a second mobile router of a moving network, which method comprises the steps of:
establishing a communications connection with a first mobile router of the moving network, which first mobile router is assigned a first prefix for use when passing traffic to and from a home agent with which the first mobile router is associated;
receiving second prefix delegation information from said first mobile router over said communications connection delegating the right to use said first prefix to said second mobile router, which second prefix delegation information includes second authentication information that may be compared to first authentication information to verify that the second mobile router has the right to use said first prefix;
sending a request for a prefix delegation utilization to said home agent which utilization request includes said second authentication information; and
establishing a bidirectional tunnel for passing traffic using said first prefix between said second mobile router and said home agent.

9. The method according to claim 8, further including the step of including said first prefix in a Router Advertisement of the second mobile router after establishment of the bidirectional tunnel.

10. The method according to claim 8, further including the step of sending a request for a delegation of said first prefix to said first mobile router and wherein said step of establishing said communications connection is initiated from said first mobile router in response to reception of said delegation request.

11. The method according to claim 8, wherein said steps of sending a request for prefix delegation utilization and establishing the bidirectional tunnel includes performing an Internet Key Exchange procedure with the home agent, sending a Binding Update to the home agent and establishing the bidirectional tunnel according to the NEMO Basic Support protocol.

12. A method in a home agent having an associated first mobile router of a moving network, which first mobile router is assigned a first prefix for use when passing traffic to and from the home agent, which method comprises the steps of:
receiving first prefix delegation information from said first mobile router delegating the right to use said first prefix to a second mobile router of said moving network, which first prefix delegation information includes first authentication information;
receiving a request for a prefix delegation utilization from said second mobile router which utilization request includes second authentication information;
authorizing the prefix delegation of said first prefix to said second mobile router if a comparison of said first authentication information and said second authentication information verifies that the second mobile router has the right to use said first prefix; and
establishing a bidirectional tunnel for passing traffic using said first prefix between said second mobile router and the home agent if said prefix delegation was authorized.

13. The method according to claim 12 wherein said step of receiving first prefix delegation information from said first mobile router includes receiving information on a determined trust level of the second mobile router.

14. The method according to claim 12, wherein said first prefix delegation information is received from said first mobile router in a Binding Update.

15. The method according to claim 12, wherein said steps of receiving a request for prefix delegation utilization, authorizing the prefix delegation and establishing the bidirectional tunnel includes performing an Internet Key Exchange procedure with the second mobile router registering the second mobile router in the home agent through a Binding Update procedure and establishing the bidirectional tunnel according to the NEMO Basic Support protocol.

16. The method according to claim 12, including the further step of revoking the delegation of said first prefix to said second mobile router, which revocation step includes closing said bidirectional tunnel.

17. The method according to claim 16, wherein said revocation step is performed in response to reception of a revocation message from the first mobile router.

18. The method according to claim 1, wherein said first and second authentication information each includes a delegation MR-ID which identifies the delegation of the right to use the first prefix to the second mobile router.

19. The method according to claim 18, wherein at least one of said first and second authentication information includes a set of credentials such as a pre-shared key, a certificate, a password or a PIN-code generated by said first mobile router and associated with said delegation MR-ID.

20. The method according to claim 1, wherein the delegation of said first prefix to said second mobile router is associated with a lifetime of the delegation which indicates the period during which the delegation is valid.

21. The method according to claim 1, wherein said first prefix delegation information further includes the first prefix and/or an identity of the first mobile router.

22. The method according to claim 1, wherein said second prefix delegation information further includes the first prefix and/or an address of the home agent.

23. The method according to claim 1, wherein said second mobile router belongs to another home agent than the first mobile router.

24. A first mobile router of a moving network, which first mobile router is arranged to be assigned a first prefix for use when passing traffic to and from a home agent with which the first mobile router is associated, the first mobile router comprising:
a communications interface for establishing a communications connection with a second mobile router of the moving network; and
means for delegating the right to use said first prefix to said second mobile router which means for delegating includes means for transferring first prefix delegation information to said home agent and means for transferring second prefix delegation information to said second mobile router over said communications connection, which first and second prefix delegation information includes first and second authentication information respectively that may be compared to verify that the second mobile router has the right to use said first prefix and wherein the first and second authentication information comprise identity information associated with the second mobile router and a set of credentials associated with the identify information.

25. The first mobile router according to claim 24, wherein said first mobile router further includes means for determining a trust level of the second mobile router based on identity information received from said second mobile router, wherein said means for transferring first prefix delegation information to said home agent is arranged to transfer information on said determined trust level to said home agent, and wherein said communications interlace is arranged to establish the communications connection as an IP Security connection or other secure communications connection.

26. The first mobile router according to claim 24, which first mobile router further includes means for revoking the delegation of said first prefix to said second mobile router which means for revoking are arranged to send a revocation message to said home agent.

27. The first mobile router according to claim 24, which first mobile router further includes means for updating the delegation of said first prefix to said second mobile router, which means for updating are arranged to send a first updating message including changes to said first prefix delegation information to said home agent and to send a second updating message including changes to said second prefix delegation information to said second mobile router.

28. The first mobile router according to claim 24, wherein the second mobile router belongs to another home agent than the first mobile router.

29. A second mobile router of a moving network, the second mobile router comprising:
a communications interface for establishing a communications connection with a first mobile router of the moving network, which first mobile router is assigned a first prefix for use when passing traffic to and from a home agent with which the first mobile router is associated;
means for receiving second prefix delegation information from said first mobile router over said communications connection delegating the right to use said first prefix to said second mobile router, which second prefix delegation information includes second authentication information that may be compared to first authentication information to verify that the second mobile router has the right to use said first prefix, and wherein the first and second authentication information comprise identity information associated with the second mobile router and a set of credentials associated with the identify information; and
means for sending a request for a prefix delegation utilization to said home agent which utilization request includes said second authentication information; and means for establishing a bidirectional tunnel for passing traffic using said first prefix between said second mobile router and said home agent.

30. The second mobile router according to claim 29, further including means for including said first prefix in a Router Advertisement of the second mobile router after establishment of the bidirectional tunnel.

31. The second mobile router according to claim 29, wherein said means for sending a request for prefix delegation utilization and said means for establishing the bidirectional tunnel are arranged to perform an Internet Key Exchange procedure with the home agent, send a Binding Update to the home agent and establish the bidirectional tunnel according to the NEMO Basic Support protocol.

32. The second mobile router according to claim 29, wherein the second mobile router belongs to another home agent than the first mobile router.

33. A home agent arranged to be associated with a first mobile router of a moving network, which first mobile router is assigned a first prefix for use when passing traffic to and from the home agent, which home agent comprises:
means for receiving first prefix delegation information from said first mobile router delegating the right to use said first prefix to a second mobile router of said moving network, which first prefix delegation information includes first authentication information;
means for receiving a request for a prefix delegation utilization from said second mobile router which utilization request includes second authentication information;
means for authorizing the prefix delegation of said first prefix to said second mobile router if a comparison of said first authentication information and said second authentication information verifies that the second mobile router has the right to use said first prefix; and
wherein the first and second authentication information comprise identity information associated with the second mobile router and a set of credentials associated with the identify information; and
means for establishing a bidirectional tunnel for passing traffic using said first prefix between said second mobile router and the home agent if said prefix delegation was authorized.

34. The home agent according to claim 33 wherein said means for receiving first prefix delegation information from said first mobile router includes means for receiving information on a determined trust level of the second mobile router.

35. The home agent according to claim 33, wherein said means for receiving first prefix delegation information is arranged to receive said first prefix delegation information from said first mobile router in a Binding Update.

36. The home agent according to claim 33, wherein said means for receiving a request for prefix delegation utilization, said means for authorizing the prefix delegation and said means for establishing the bidirectional tunnel are arranged to perform an Internet Key Exchange procedure with the second mobile router, to register the second mobile router in the home agent through a Binding Update procedure and to establish the bidirectional tunnel according to the NEMO Basic Support protocol.

37. The home agent according to claim 33, wherein the second mobile router belongs to another home agent than the first mobile router.

38. A communications system, comprising:
a moving network including a first and a second mobile router, and a home agent associated with the first mobile router, which first mobile router is assigned a first prefix for use when passing traffic to and from the home agent, which first mobile router is arranged to delegate the right to use said first prefix to said second mobile router by transferring first prefix delegation information to the home agent and second prefix delegation information to said second mobile router, which first and second prefix delegation information includes first and second authentication information respectively that may be compared to verify that the second mobile router has the right to use said first prefix and wherein the first and second authentication information comprise identity information associated with the second mobile router and a set of credentials associated with the identify information.

39. The communication system according to claim 38, wherein said second mobile router is arranged to send a request for a prefix delegation utilization to said home agent which utilization request includes said second authentication information.

40. The communication system according to claim 39, wherein the home agent is arranged to authorize the prefix delegation of said first prefix to said second mobile router if a comparison of said first authentication information and said second authentication information verifies that the second mobile router has the right to use said first prefix and to establish a bidirectional tunnel for passing traffic using said first prefix between said second mobile router and the home agent if said prefix delegation was authorized.

41. The communication system according to claim 38, wherein the second mobile router belongs to another home agent than the first mobile router.
